(19) United States
(12) Patent Application Publication
(10) Pub. No.: US 2004/0244825 A1
(43) Pub. Date: Dec. 9, 2004

(54) Dishwasher with drawer lifting mechanism

(76) Inventor: Robert H. Ashton, Watervliet, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 10/456,600

(22) Filed: Jun. 6, 2003

(51) Int. Cl. B08B 3/00

(52) U.S. Cl. 134/85; 134/92; 134/117; 134/159; 134/160; 134/164; 134/165

(57) ABSTRACT

A household dishwashing machine of the type having a wash chamber in the form of a drawer, with the drawing being moveable between a lowered to a raised position for facile loading and unloading of the dishes.

### BACKGROUND OF THE INVENTION

1. Field of the Invention

The invention relates generally to a household dishwashing machine with a drawer lifting mechanism and more particularly to a household dishwashing machine of the type having a wash chamber in the form of a drawer wherein the height of the drawer can be adjusted with a drawer lifting mechanism.

2. Description of the Related Art

Household dishwashing machines having the appearance of a cabinet are known. Such dishwashers generally have at least one drawer that forms a wash tub, and if two or more drawers are employed, then usually each drawer functions as a separate wash tub. Cabinet dishwashers are desirable because the drawers are simple to use and the user does not have to manipulate a conventional pull-down door. Furthermore, the cabinet dishwashers have a sleek appearance that integrates well with other cabinet structures in the kitchen.

Loading and unloading the dish drawer of a cabinet dishwashing machine, however, can be difficult because the drawer can be located at a relatively low position, which may require some users to bend over or reach further than is comfortable.

### SUMMARY OF THE INVENTION

The invention relates to a household dishwasher with a drawer lift mechanism that can move the drawer between a conventional initial fill/empty position and a raised position that permits facile loading and a unloading of the drawer.

Specifically, the invention relates to a dishwasher comprising a housing defining an interior chamber having an open face providing access to the interior chamber, a first drawer is moveably mounted to the housing for movement between a wash position, where the first drawer is disposed inside the interior chamber, and a fill/empty position, where at least a portion of the first drawer extends out of the interior chamber. A dish rack is carried by the first drawer and holds the dishes to be cleaned. A drawer lift mechanism moves the first drawer between the fill/empty position and a raised position above the fill/empty position.

When the first drawer is in the raised position, the dish rack is located approximately 24-36 inches above a floor on which the dishwasher sets, and/or the drawer lift mechanism raises the first drawer approximately 12-24 inches.

The dishwasher can optionally comprise a second drawer moveably mounted to the housing for movement between a wash position where the second drawer is disposed inside the interior chamber above the first drawer and a fill/empty position where at least a portion of the second drawer extends out of the interior chamber. When the first drawer is in the raised position, the first drawer is approximately at the same height as the second drawer.

The first drawer of the dishwasher comprises a bottom wall and a peripheral side wall extending upwardly from the bottom wall to define an open-top wash chamber in which the dish rack is located, wherein the dish rack is removably mounted to the first drawer in the open-top wash chamber.

The lift mechanism can be a scissor lift operable between a retracted position and an extended position to move the first drawer to the raised position when the scissor lift is in the extended position. The scissor lift can comprise a pair of hingedly connected arms, each arm having a lower end and an upper end, the lower ends being coupled to the housing and the upper ends coupled to the first drawer, and a drive mechanism for rotating the arms about the hinge to move the scissor lift between the retracted and extended positions.

The drive mechanism comprises a motor-driven lead screw coupled between the arms such that the rotation of the lead screw in a first direction separates the arms to move the scissor lift into the expanded position, and the rotation of the lead screw in a second direction, opposite the first direction, collapses the arms to move the scissor lift into the retracted position. The lift mechanism can further comprise an actuator that automatically moves the drawer between the raised position and the fill/empty position in response to a user-applied force to the drawer.

The dishwasher can further comprise a drawer slide moveably mounting the first drawer to the housing for slidable movement between the wash and the fill/empty positions, and the lower ends of the arms are mounted to the drawer slide. The drawer slide comprises first and second rails coupled together for relative slidable movement, with the first rail mounted to the housing and the second rail mounted to the drawer, and the lower ends of the arms are slidably mounted to the second rail.

In another aspect, the invention relates to a dishwasher comprising a housing defining an interior chamber having an open face providing access to the interior chamber. A first drawer is moveably mounted to the housing for movement between a wash position, where the first drawer is disposed inside the interior chamber, and a fill/empty position, where at least a portion of the first drawer extends out of the interior chamber. A second drawer is moveably mounted to the housing above the first drawer for movement between a wash position, where the second drawer is disposed inside the interior chamber, and a fill/empty position, where at least a portion of the second drawer extends out of the interior chamber. A dish rack is carried by the first drawer and holds dishes to be cleaned. A drawer lift mechanism is provided for moving the first drawer between the fill/empty position and a raised position above the fill/empty position.

When the first drawer is in the raised position, the first drawer is preferably approximately at the same height as the second drawer, and/or the dish rack is located approximately 24-36 inches above a floor on which the dishwasher sets. The drawer lift mechanism preferably raises the first drawer approximately 12-24 inches.

The dishwasher further comprises a drawer slide that moveably mounts the first drawer to the housing for slidable movement between the wash and the fill/empty positions. The drawer slide can comprise first and second rails coupled together for relative slidable movement, with the first rail mounted to the housing and the second rail mounted to the drawer, and the lower ends of the arms are slidably mounted to the second rail.

The lift mechanism can be a scissor lift mounted to the drawer slide and operable between a retracted position and an extended position to move the first drawer to the raised position when the scissor lift is in the extended position. The scissor lift can comprise a pair of hingedly connected arms, each arm having a lower end and an upper end, the lower ends being coupled to the drawer slide and the upper ends coupled to the drawer, and a drive mechanism for rotating the arms about the hinge to move the scissor lift between the retracted and extended positions.

The drive mechanism can be in the form of a motor-driven lead screw coupled between the arms such that the rotation of the lead screw in a first direction separates the arms to move the scissor lift into the expanded position, and the rotation of the lead screw in a second direction, opposite the first direction, collapses the arms to move the scissor lift into the retracted position. The lift mechanism can further comprise an actuator that automatically moves the drawer between the raised position and the fill/empty position in response to a user-applied force to the drawer.

### BRIEF DESCRIPTION OF THE DRAWINGS

In the drawings:

FIG. 1 is a perspective view of a household dishwasher having a drawer lift mechanism according to the invention, wherein the dishwasher has a first drawer below a second drawer, the first drawer is shown in a fill/empty position, and the second drawer is in a wash position.

FIG. 2 is a schematic side view of the household dishwasher of FIG. 1 with the first drawer in the wash position.

FIG. 3 is a schematic rear view of the household dishwasher of FIG. 1 with the first drawer in the wash position.

FIG. 4 is a schematic side view of the household dishwasher of FIG. 1 with the first drawer in the fill/empty position.

FIG. 5 is a schematic side view of the household dishwasher of FIG. 1 with the first drawer in a raised position.

FIG. 6 is a schematic side view of a second embodiment household dishwasher of FIG. 1 with an alternative drawer lift mechanism according to the invention, wherein the first drawer is in the fill/empty position.

FIG. 7 is a schematic rear view of the household dishwasher of FIG. 6 with the first drawer in the fill/empty position.

FIG. 8 is a schematic side view of the household dishwasher of FIG. 6 with the first drawer in a raised position.

### DESCRIPTION OF THE PREFERRED EMBODIMENT

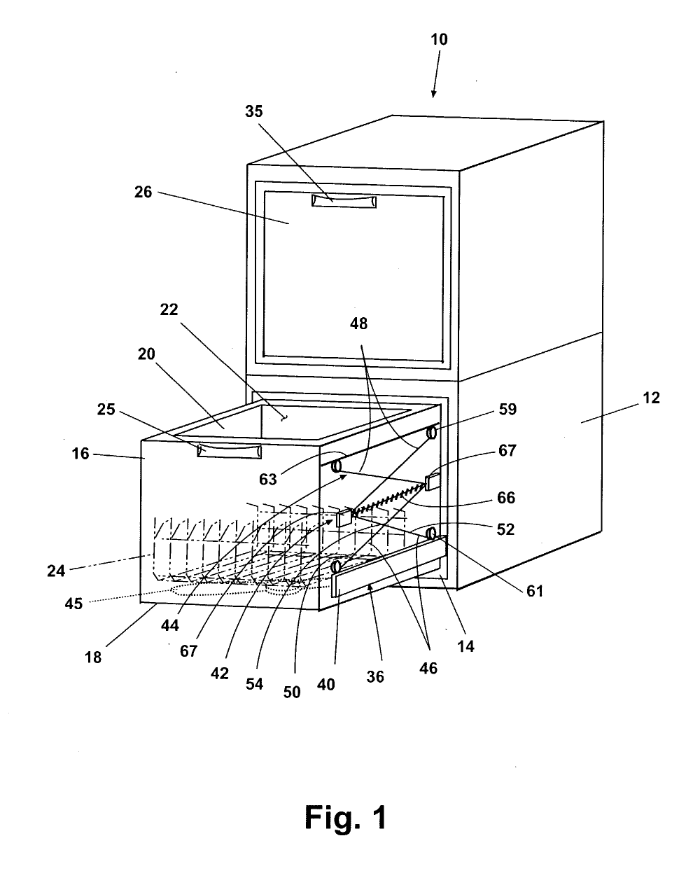

Referring now to the drawings, FIG. 1 illustrates a household dishwasher 10 comprising a housing 12 defining an interior chamber 14 having an open face providing access to the interior chamber 14. First and second drawers 16, 26 are moveably mounted to the housing 12 for movement between a wash position, as illustrated by the second drawer 26, where the drawer is disposed inside the interior chamber 14 and a fill/empty position, as illustrated by the first drawer 16, where at least a portion of the drawer extends out of the interior chamber 14.

Each of the drawers 16, 26 forms a separate wash chamber for washing dishes and the like. Functionally, each drawer 16, 26 can be thought of as a separate dishwasher. Although the first and second drawers 16, 26 are illustrated as being mounted within the same housing 12 and in a stacked configuration, it is within the scope of the invention for each drawer to have a separate housing and to be arranged in configurations other than a stacked arrangement. It is also within the scope of the invention for any number of drawers, from a single drawer to a plurality of drawers, to be used.

The first drawer 16 comprises a bottom wall 18 and a peripheral side wall 20 extending upwardly from the bottom wall 18 that define an open-top wash chamber 22 having a dish rack 24 therein. The dish rack 24 is preferably removably mounted to the first drawer 16. A handle/pull 25 is located on a front portion of the peripheral wall 20.

Similar to the first drawer 16, the second drawer 20 comprises a bottom wall 30 and a peripheral side wall 32 extending upwardly from the bottom wall 30 that define an open-top wash chamber 34 with a second dish rack (not shown) located therein. The second dish rack is preferably removably mounted to the interior of the second drawer 26. A handle/pull 35 is located on a front portion of the peripheral wall 32.

The first and second drawers 16 and 26 are slidably mounted to the housing 12 by a pair of drawer slides 36. Since the same drawer slides 36 are preferably used for both drawers 16, 26, only the drawer slide 36 for the first drawer 16 will be described, with it being understood the description applies to the drawer slide 36 for the second drawer 26.

Each drawer slide 36 comprises a first rail 38 and a second rail 40 coupled together for relative slidable movement by rollers 41 and 43, which are mounted, such as by journaling, to the first and second rails 38, 40, respectively. The first rail 38 is mounted to the housing 12 and the second rail 40 is coupled to the first drawer 16, thereby moveably mounting the first drawer 16 to the housing 12 and facilitating movement of the first drawer 16 between the wash and fill/empty positions.

The preferred drawer slides 36 as described are well known and need not be described further. It should be noted that if further extension of the drawer 16, 26 is required, the drawer slides 36 can include more rails to permit the complete extension of the drawer 16, 26 beyond the housing 12. In addition, any other type of drawer slides, which are well known, or any other mechanism suitable for facilitating movement of drawers between the wash and fill/empty positions can be utilized.

Each drawer 16, 26 also comprises a liquid recirculation system 45 for introducing, recirculating, and draining liquid. The type of liquid recirculation system used is not germane to the invention. Any suitable type of recirculation system can be used, such as those disclosed in U.S. Pat. No. 6,447,081, which is incorporated by reference.

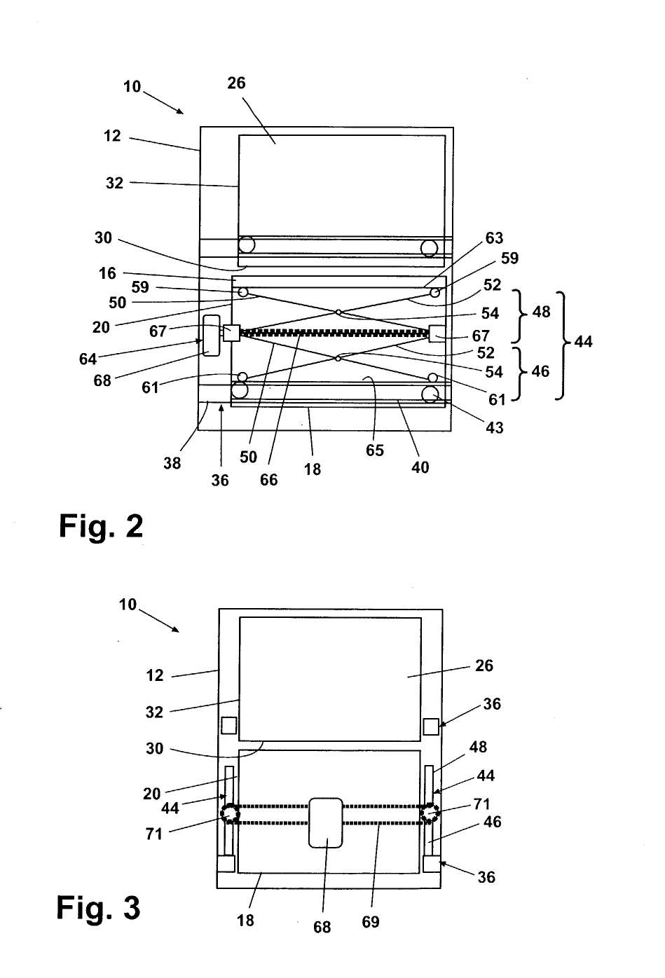

The dishwasher 10 further comprises a drawer lift mechanism 42 for the first drawer 16. A first embodiment of the drawer lift mechanism 42 is shown in FIGS. 2-5, which do not show the liquid recirculation system 45 for clarity, and comprises identical scissor lifts 44 disposed on opposite sides of the first drawer 16. Each scissor lift 44 has lower and upper pairs 46, 48 of arms 50, 52, which are connected by a hinge pin 54 at their crossing point. Each pair 46, 48 have a lower end and an upper end. Rollers 59 are rotatably mounted to the upper ends of the arms 50, 52 of the upper arm pair 48. Similarly, rollers 61 are rotatably mounted to the lower ends of the lower arm pair 46. The rollers 59 are received in a track/rail 63 on the upper portion of the drawer. The rollers 61 ride on a track/rail 65 formed in an upper portion of the second rail 40.

A drive mechanism 64 connects the lower ends of the upper arm pair 48 and the upper ends of the lower arm pair 46 such that the drive mechanism can draw together or move apart the lower ends of the upper arm pair 48 and the upper ends of the lower arm 46 pair to extend and collapse the arm pairs 46, 48 and thereby raise and lower the drawer 16.

As illustrated, the preferred form of the drive mechanism 64 comprises lead screws 66 mounted on opposite sides of the drawer. Each lead screw 66 carries threaded drive blocks 67, which are threaded onto the lead screw 66 and which rotatably mount the lower ends of the upper arm pair 48 and the upper ends of the lower arm pair 46. A motor 68 is coupled to the lead screws 66 by a chain 69 entrained about drive gears 71 mounted to the end of each lead screw 66. The actuation of the motor 68 drives the chain 69, which turns the drive gears 71 to rotate the lead screws 66. The rotation of the lead screws 66 results in the drive blocks traveling toward or away from each other along the lead screws 66 to effect the extension or collapsing of the upper and lower arm pairs 46, 48, respectively. Alternatively, rather than utilizing a single motor 68 and a chain 69, two motors, one disposed on each side of the drawer 16, could be used to turn the drive gears 71 and thereby rotate the lead screws 66.

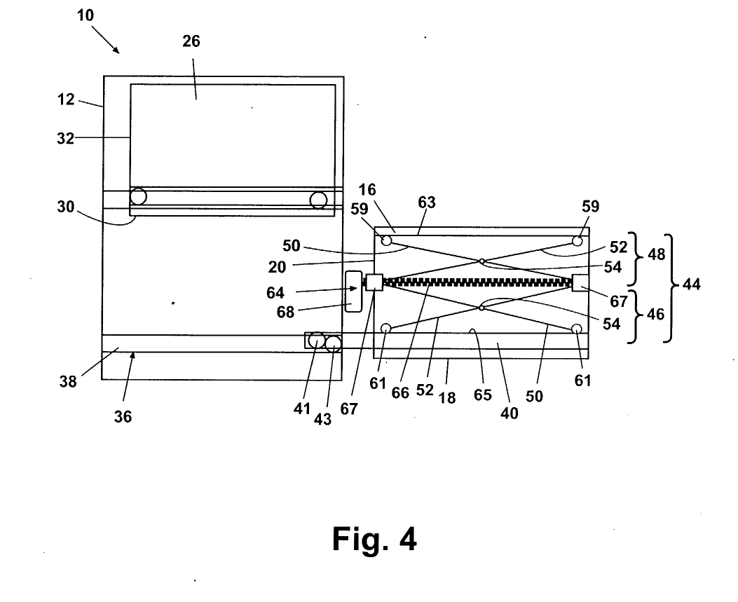

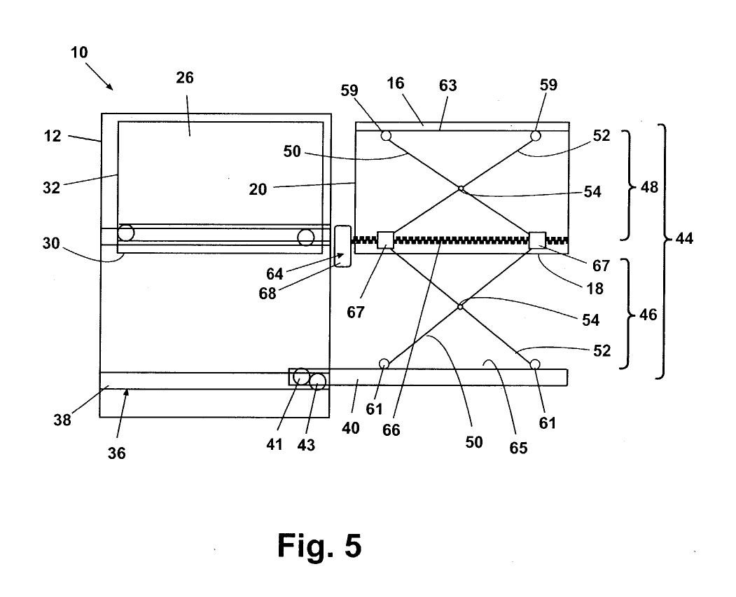

In operation, a user desiring to load or unload the first drawer 16 grasps the drawer handle/pull 25 and moves the first drawer 16 in the fill/empty position, as illustrated in FIG. 4 by sliding the drawer 16 on the drawer slides 36. The drawer handle/pull 25 preferably includes a switch to activate the motor 68 to drive the chain loop 69, which thereby rotates the lead screws 66 as previously described. As the lead screws 66 are rotated, the threaded drive blocks 67 move towards each other, extending the arm pairs 46, 48 as they rotate about the hinge pins 54, causing the rollers 59, 61 to follow the corresponding track/rail 63, 65 and thereby elevating the first drawer 16 to a raised position (FIG. 5) above the fill/empty position.

When the first drawer 16 is in the raised position, the first drawer 16 is sufficiently elevated to accommodate facile loading and unloading of the first drawer 16 by persons with back pain, inadequate flexibility, or other physical limitations. For example, when the first drawer 16 is in the raised position, the dish rack 24 can be located approximately 24-36 inches above a floor on which the dishwasher 10 sets. In terms of the displacement of the first drawer 16, the drawer lift mechanism 42 can raise the first drawer 16 approximately 12-24 inches. When the dishwasher 10 comprises a second drawer 26, the first drawer 16, when in the raised position, can be located at approximately the same height as the second drawer 26. Different heights and range of movement can be achieved by altering the length of the arms 50, 52 or the number of arm pairs 46, 48.

When the user desires to lower the first drawer 16 to the fill/empty position, the user activates the motor 68 using the switch on the handle 25 to drive the chain loop 69 in the reverse direction, thereby rotating the lead screw 66 in the reverse direction. As the lead screw 66 is rotated in the reverse direction, the drive blocks 67 move away from each other, and each pair 46, 48 of arms 50, 52 rotate about the hinge pin 54 and move to a retracted position, best seen in FIG. 4, thereby lowering the first drawer 16 to the fill/empty position.

While it is preferred that the arms 50, 52 be connected by the hinge pin 54, it is not necessary. If the hinge pin 54 is used, the upper and lower ends of the arms 50, 52 must be free to move laterally as the scissor lift 44 is extended or collapsed, which requires that a corresponding track/rail be provided to support the movement of the ends of the arms 50, 52. However, if a hinge pin 54 is not used, then the ends of the arms 50, 52 not connected to the drive blocks 67 can be rotatably pinned to the drawer and eliminate the need for the track/rail.

For simplicity, it is preferred that the motor 68 is actuated by a switch located on or around the handle/pull 25, or the motor 68 can be activated by any other suitable mechanism. For example, force sensors can be coupled to the drawer such that they detect a user-applied lifting/lowering force and will appropriately raise or lower the drawer, depending on the current position of the drawer.

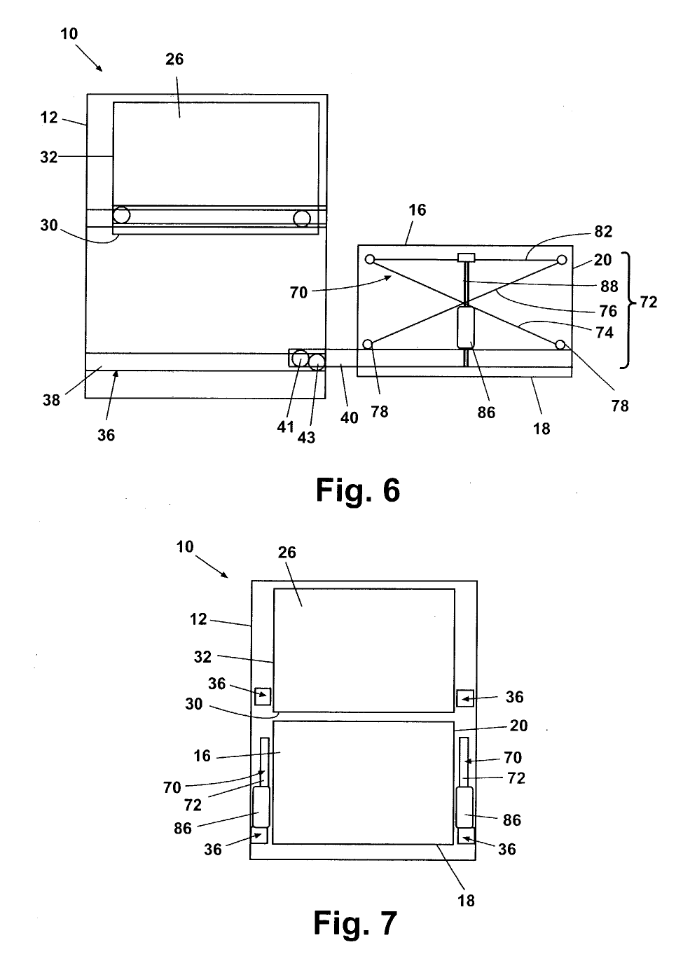

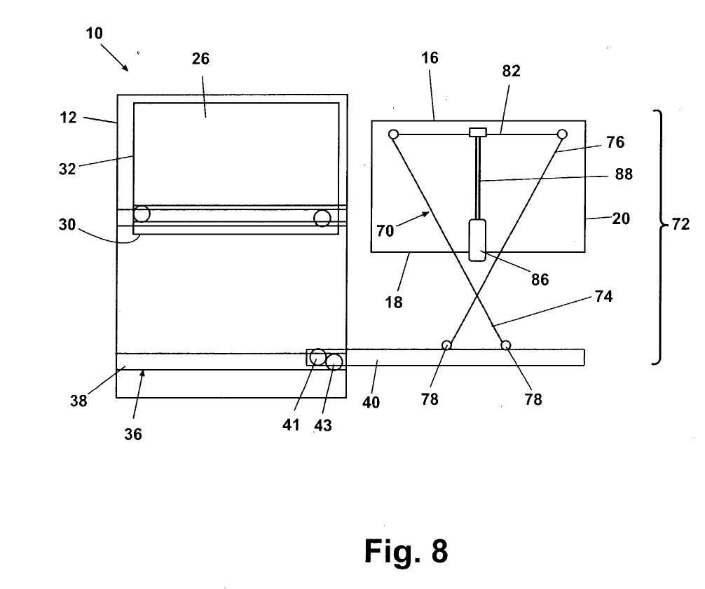

FIGS. 6-8 illustrate a second embodiment of the dishwasher with lift drawer. The second embodiment is identical to the first embodiment, except for the type of lift mechanism to raise and lower the drawer. Therefore, like numerals will be used to identify like parts and only the new lift mechanism is described in detail, with it being understood that the description of the relevant portions of the first embodiment applies to the second embodiment.

The lift mechanism for the second embodiment is also a scissor lift mechanism and comprises identical scissor lifts 70 disposed on opposite sides of the first drawer 16. Each scissor lift 70 comprises a single pair 72 of crossing arms 74, 76 having a lower end and an upper end. Unlike the first embodiment, the arms 74, 76 are not connected at their cross over point. Rollers 78 are mounted to the lower ends of the arms 74, 76 and are slidably mounted to the second rail 40 of the slide 36. Unlike the first embodiment, the upper ends of the arms 74, 76 are pivotally connected to a crossbar 82, which is connected to an upper portion of the drawer 16. A drive mechanism in the form of a linear actuator 86 having a telescoping rod 88 is used to move the arms 74, 76 between the extended and collapsed positions. The linear actuator 86 is mounted to the second rail 40 and the telescoping rod 88 is mounted to the crossbar 82.

To raise the first drawer 16, the linear actuator 86 is activated in the same manner as the motor for the first embodiment, and the telescoping rod 88 extends, thereby causing the crossbar 82 to ascend. As the crossbar 82 travels upward, the arms 74, 76 move to an extended position as the rollers 78 of the lower ends of the arms 74, 76 slide towards each other, thereby elevating the first drawer 16 to the raised position above the fill/empty position. To lower the first drawer 16 from the raised position, the linear actuator 86 is activated, and the telescoping rod 88 retracts, thereby causing the crossbar 82 to descend. As the crossbar 82 travels downward, the arms 74, 76 move to a retracted position as the rollers 78 slide away from each other at the lower end, thereby lowering the first drawer 16 to the fill/empty position.

Lift mechanisms are devices well known to those skilled in the art, and the drawer lift mechanism of the present invention is not limited to the scissor lift mechanisms described herein. The drawer lift mechanism can be of any type suitable for raising and lowering a dishwasher drawer. For example, the lift mechanism can comprise hydraulic, pneumatic, or other types of propelling systems known to those skilled in the art.

While the invention has been specifically described in connection with certain specific embodiments thereof, it is to be understood that this is by way of illustration and not of limitation, and the scope of the appended claims should be construed as broadly as the prior art will permit.

What is claimed is:

1. A dishwasher comprising:
a housing defining an interior chamber having an open face providing access to the interior chamber;
a first drawer moveably mounted to the housing for movement between a wash position where the first drawer is disposed inside the interior chamber and a fill/empty position where at least a portion of the first drawer extends out of the interior chamber; and
a drawer lift mechanism moving the first drawer between the fill/empty position and a raised position above the fill/empty position.

2. The dishwasher of claim 1, wherein the first drawer has a bottom wall and when the first drawer is in the raised position, the bottom wall is located approximately 24-36 inches above a floor on which the dishwasher sets.

3. The dishwasher of claim 1, wherein the drawer lift mechanism raises the first drawer approximately 12-24 inches.

4. The dishwasher of claim 1, and comprising a second drawer moveably mounted to the housing for movement between a wash position where the second drawer is disposed inside the interior chamber above the first drawer and a fill/empty position where at least a portion of the first drawer extends out of the interior chamber.

5. The dishwasher according to claim 4, wherein when the first drawer is in the raised position, the first drawer is approximately at the same height as the second drawer.

6. The dishwasher according to claim 4, wherein the first drawer has a bottom wall and when the first drawer is in the raised position, the bottom wall is located approximately 24-36 inches above a floor on which the dishwasher sets.

7. The dishwasher of claim 4, wherein the drawer lift mechanism raises the first drawer approximately 12-24 inches.

8. The dishwasher of claim 1, and further comprising a dish rack carried by the first drawer for holding dishes to be cleaned.

9. The dishwasher of claim 8, wherein the first drawer comprises a bottom wall and a peripheral side wall extending upwardly from the bottom wall to define an open-top wash chamber in which the dish rack is located.

10. The dishwasher of claim 9, wherein the dish rack is removably mounted to the first drawer in the open-top wash chamber.

11. The dishwasher of claim 1, wherein the lift mechanism is a scissor lift operable between a retracted position and extended position to move the first drawer to the raised position when the scissor lift is in the extended position.

12. The dishwasher of claim 11, wherein the scissor lift comprises a pair of hingedly connected arms, each arm having a lower end and an upper end, the lower ends being coupled to the housing and the upper ends coupled to the first drawer, and a drive mechanism for rotating the arms about the hinge to move the scissor lift between the retracted and extended positions.

13. The dishwasher of claim 12, wherein the drive mechanism comprises a motor-driven lead screw coupled between the arms such that the rotation of the lead screw in a first direction separates the arms to move the scissor lift into the expanded position, and the rotation of the lead screw in a second direction, opposite the first direction, collapses the arms to move the scissor lift into the retracted position.

14. The dishwasher of claim 13, and further comprising a drawer slide moveably mounting the first drawer to the housing for slidable movement between the wash and the fill/empty positions, and the lower ends of the arms are mounted to the drawer slide.

15. The dishwasher of claim 14, wherein the drawer slide comprises first and second rails coupled together for relative slidable movement, with the first rail mounted to the housing and the second rail mounted to the drawer, and the lower ends of the arms are slidably mounted to the second rail.

16. The dishwasher of claim 1, wherein the lift mechanism further comprises an actuator that automatically moves the drawer between the raised position and the fill/empty position in response to a user applied force to the drawer.

17. A dishwasher comprising:
a housing defining an interior chamber having an open face providing access to the interior chamber;
a first drawer moveably mounted to the housing for movement between a wash position where the first drawer is disposed inside the interior chamber and a fill/empty position where at least a portion of the first drawer extends out of the interior chamber;
a second drawer moveably mounted to the housing above the first drawer for movement between a wash position where the first drawer is disposed inside the interior chamber and a fill/empty position where at least a portion of the first drawer extends out of the interior chamber; and
a drawer lift mechanism moving the first drawer between the fill/empty position and a raised position above the fill/empty position.

18. The dishwasher according to claim 17, wherein when the first drawer is in the raised position, the first drawer is approximately at the same height as the second drawer.

19. The dishwasher of claim 17, wherein the first drawer has a bottom wall and when the first drawer is in the raised position, the bottom wall is located approximately 24-36 inches above a floor on which the dishwasher sets.

20. The dishwasher of claim 17, wherein the drawer lift mechanism raises the first drawer approximately 12-24 inches.

21. The dishwasher of claim 17, and further comprising a drawer slide moveably mounting the first drawer to the housing for slidable movement between the wash and the fill/empty positions.

22. The dishwasher of claim 21, wherein the lift mechanism is a scissor lift mounted to the drawer slide and operable between retracted position and extended positions to move the first drawer to the raised position when the scissor lift is in the extended position.

23. The dishwasher of claim 22, wherein the scissor lift comprises a pair of hingedly connected arms, each arm having a lower end and an upper end, the lower ends being coupled to the drawer slide and the upper ends coupled to the drawer, and a drive mechanism for rotating the arms about the hinge to move the scissor lift between the retracted and extended positions.

24. The dishwasher of claim 23, wherein the drawer slide comprises first and second rails coupled together for relative slidable movement, with the first rail mounted to the housing and the second rail mounted to the drawer, and the lower ends of the arms are slidably mounted to the second rail.

25. The dishwasher of claim 24, wherein the drive mechanism comprises a motor-driven lead screw coupled between the arms such that the rotation of the lead screw in a first direction separates the arms to move the scissor lift into the expanded position, and the rotation of the lead screw in a second direction, opposite the first direction, collapses the arms to move the scissor lift into the retracted position.

26. The dishwasher of claim 25, wherein the lift mechanism further comprises an actuator that automatically moves the drawer between the raised and fill/empty position in response to a user applied force to the drawer.

27. The dishwasher of claim 17, and further comprising a dish rack carried by the first drawer for holding dishes to be cleaned.
